(19) United States
(12) Patent Application Publication
(10) Pub. No.: US 2019/0152190 A1
(43) Pub. Date: May 23, 2019

(54) MULTI-LAYER FILM AND PACKAGING WITH SAME

(71) Applicant: Sunbeam Products, Inc., Boca Raton, FL (US)

(72) Inventors: Chad M. Perre, Appleton, WI (US); Charles R. Harder, Reno, NV (US)

(21) Appl. No.: 16/091,802

(22) PCT Filed: Apr. 4, 2017
(86) PCT No.: PCT/US2017/025852

§ 371 Date: Oct. 5, 2018

Related U.S. Application Data
(60) Provisional application No. 62/318,606, filed on Apr. 5, 2016.

(51) Int. Cl. B32B 7/12; B32B 27/08; B32B 27/32

(52) U.S. Cl. CPC B32B 7/12; B32B 27/08; B32B 27/32; B32B 2307/31; B32B 2323/046; B32B 2307/7246; B32B 2439/70

(57) ABSTRACT

The present disclosure provides a multilayer film. In an embodiment, the multilayer film includes a sealant layer. The sealant layer includes from (i) 50 wt % to 95 wt % ethylene copolymer having a density of at least 0.918 g/cc and (ii) from 50 wt % to 5 wt % of a 1-butene polymer having a density of at least 0.913 g/cc.

### BACKGROUND

Consumers vacuum seal foods in a storage container to improve the longevity of the foods. A vacuum sealer is used in tandem with, for example, a vacuum sealed bag to provide a system which delivers long term storage of food. Food is inserted into a bag through an open end and then inserted into a vacuum sealer. The vacuum sealer pulls a vacuum removing the air from the bag and pulling the bag tightly around the food. Once vacuumed the open end of the bag is heat sealed to maintain the vacuum. The other part of the food preservation equation is the bag's structure and component materials. Typically, the bag is formed from a multilayer structure of barrier materials which keep the air out and the water in. The inner most layers are designed to melt when subjected to enough heat, time, and pressure together and when they cool they seal together making an air and water tight seal.

Today's vacuum seal bags form such a tight seal the only way to open them is to cut the bag below the heat sealed area so the consumer can access the food. The action of cutting the bag requires an extra tool causing inconvenience. Furthermore some foods, as an example refrigerated marinated meat, have liquids and the action of cutting the bag can cause a mess where the liquids may leak from the bag when cut. Vacuum bags using a peelable film have been developed so that the bag may be opened by peeling apart the heat sealed layers.

### Peelable Films

There are several known methods of making a peelable plastic film. They are commonly used in food products in the grocery store. However FOODSAVER® heat seal bags are designed to be microwaved, sous vide cooked, and warmed by simmering water. Known bags made from a peelable film are not able to maintain the seal integrity after heating at or above 190° F. (88° C.). When handled at these temperatures the peelable seals open from the weight of the contents.

### SUMMARY

The present disclosure provides a multilayer film. In an embodiment, the multilayer film includes a sealant layer. The sealant layer includes from (i) 50 wt % to 95 wt % ethylene copolymer having a density of at least 0.918 g/cc and (ii) from 50 wt % to 5 wt % of a 1-butene polymer having a density of at least 0.913 g/cc.

The multilayer film can be used to produce food storage bags. In an embodiment, the present disclosure provides a food storage bag which includes opposing flexible multilayer films superimposed upon each other to form a common peripheral edge. Each multilayer film includes a sealant layer, and the sealant layers face each other. Each sealant layer includes (i) from 50 wt % to 95 wt % ethylene copolymer having a density of at least 0.918 g/cc, and (ii) from 50 wt % to 5 wt % of a 1-butene polymer having a density of at least 0.913 g/cc. A heat seal extends along at least a portion of the common peripheral edge.

In an embodiment, the food storage bag is a vacuum packaging food storage bag.

### BRIEF DESCRIPTION OF THE DRAWINGS

FIG. 1. is a schematic representation of the structure of a multilayer film in accordance with an embodiment of the present disclosure.

FIG. 2 is a top plan view of a food storage bag in an empty and flat configuration in accordance with an embodiment of the present disclosure.

FIG. 3 is a perspective view of a food storage bag and a comestible in a storage compartment thereof, in accordance with an embodiment of the present disclosure.

FIG. 3A is an enlarged view of Area 3A of FIG. 3 showing the structure of a multilayer film in accordance with an embodiment of the present disclosure.

FIG. 3B is an enlarged view of Area 3B of FIG. 3 showing the structure of a multilayer film in accordance with an embodiment of the present disclosure.

FIG. 4 is a perspective view of a peal heat seal that closes and seals the storage compartment of the food storage bag of FIG. 3, in accordance with an embodiment of the present disclosure.

FIG. 5 is a perspective view of a person activating the peel seal of FIG. 4 in accordance with an embodiment of the present disclosure.

FIG. 6 is a perspective view of a food storage bag filled with a comestible and passing the boil test in accordance with an embodiment of the present disclosure.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

“Ethylene-based polymer” and like terms refer to a polymer containing, in polymerized form, a majority weight percent of units derived from ethylene based on the total weight of the polymer. Nonlimiting examples of ethylene-based polymers include low density polyethylene (LDPE), linear low density polyethylene (LLDPE), very low density polyethylene (VLDPE), ultra low density polyethylene (ULDPE), medium density polyethylene (MDPE), high density polyethylene (HDPE).

“Olefin-based polymer” is a polymer containing, in polymerized form, a majority weight percent of an olefin, for example ethylene or propylene, based on the total weight of the polymer. Non-limiting examples of olefin-based polymers include ethylene-based polymers and propylene-based polymers.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “propylene-based polymer” is a polymer that contains more than 50 weight percent polymerized propylene monomer (based on the total weight of the polymer) and, optionally, may contain at least one comonomer.

### DETAILED DESCRIPTION

The present disclosure provides a multilayer film. In an embodiment, the multilayer film includes a sealant layer comprising from (i) 50 wt % to 95 wt % ethylene copolymer having a density of at least 0.918 g/cc and (ii) from 50 wt % to 5 wt % of a 1-butene polymer having a density of at least 0.913 g/cc.

The multilayer film includes two or more layers. The multilayer film includes from three, or four, or five, or six to seven, or eight, or nine, or 10, or more layers. In an embodiment, the multilayer film includes at least three layers, or at least five layers, one of the layers being the sealant layer.

The multilayer film has an innermost layer and an outermost layer. The sealant layer is the innermost layer of the multilayer film. When the multilayer film is configured as the food storage bag, the sealant layer, as the innermost layer, is the food contact layer as will be discussed below.

1. Sealant Layer

The sealant layer is composed of from 50 wt % to 95 wt % ethylene copolymer. An “ethylene copolymer,” as used herein, is an ethylene-based polymer having at least one comonomer (based on total weight of the polymer). Nonlimiting examples of suitable comonomers include C₃-C₈ α-olefins, such as propylene, butene, hexene, and octene.

In an embodiment, the ethylene copolymer is selected from an ethylene/butene copolymer an ethylene/hexene, copolymer, or an ethylene/octene copolymer. In a further embodiment, the ethylene copolymer is an ethylene/octene copolymer.

In an embodiment, the ethylene copolymer is a linear low density polyethylene. A “linear low density polyethylene” (or “LLDPE”) is a linear ethylene/α-olefin copolymer containing heterogeneous short-chain branching distribution comprising units derived from ethylene and units derived from at least one C₃-C₈ α-olefin comonomer. LLDPE is characterized by little, if any, long chain branching, in contrast to conventional low density polyethylene. Low density polyethylene” (or “LDPE”) is an ethylene homopolymer, or an ethylene/α-olefin copolymer comprising at least one C₃-C₁₀ α-olefin, or a C₃-C₄ α-olefin, that has a density from 0.915 g/cc to 0.925 g/cc and contains long chain branching with broad molecular weight distribution (MWD). LDPE is typically produced by way of high pressure free radical polymerization (tubular reactor or autoclave with free radical initiator).

In an embodiment, the ethylene copolymer in the sealant layer is an LLDPE that is an ethylene/octene copolymer having one, some, or all of the following properties:

(i) a density from 0.918 g/cc, or 0.919 g/cc, or 0.920 g/cc to 0.921 g/cc, or 0.922 g/cc, or 0.923 g/cc, or 0.924 g/cc; and/or

(ii) a melt index from 0.8 g/10 min, or 1.0 g/10 min, to 1.2 g/10 min, or 1.4 g 10 min; and/or

(iii) a melt temperature, Tm, from 117° C., or 118° C., or 119° C. to 120° C., or 121° C., or 122° C.

Nonlimiting examples of suitable LLDPE for the sealant layer include DOWLEX 2056 available from The Dow Chemical Company and FP120 available from Nova Chemicals.

The sealant layer also includes from 50 wt % to 5 wt % of a 1-butene polymer having a density of at least 0.913 g/cc. A “1-butene polymer,” as used herein, is a polymer containing at least 50 wt % units derived from 1-butene and optionally one or more comonomer(s) (based on total weight of the polymer). The 1-butene polymer can be a 1-butene homopolymer or a 1-butene copolymer. Nonlimiting examples of suitable comonomers include ethylene, propylene, and hexene.

In an embodiment, the 1-butene polymer is a 1-butene homopolymer having one, some, or all of the following properties:

(i) a density from 0.913 g/cc, or 0.914 g/cc, or 0.915 g/cc, or 0.916 g/cc, or 0.917 g/cc to 0.918 g/cc, or 0.919 g/cc; and/or

(ii) a melt index from 0.2 g/10 min, or 0.4 g/10 min, to 0.6 g/10 min, or 0.8 g/10 min/and/or

(iii) a melt temperature, Tm, from 125° C., or 126° C., or 127° C., or 128° C. to 129° C., or 130° C.

A nonlimiting example of a suitable 1-butene polymer is PB 0110M, available from LyondellBassell.

In an embodiment, the sealant layer is composed of (i) from 50 wt %, or 60 wt %, or 70 wt % to 80 wt %, or 90 wt %, or 95 wt % of the ethylene copolymer and a reciprocal amount of 1-butene polymer, or (ii) from 50 wt %, or 40 wt %, or 30 wt % to 20 wt %, or 10 wt %, or 5 wt % of the 1-butene polymer.

The sealant layer may include one or more optional additives. Nonlimiting examples of suitable additives include stabilizers, slip additives, antiblock agent, process aids, clarifiers, nucleators, pigments or colorants, fillers and reinforcing agents, and any combination thereof.

In an embodiment, the sealant layer includes (i) the ethylene copolymer, (ii) the 1-butene polymer, and (ii) an additive masterbatch containing an antiblock agent. The masterbatch is composed of diatomaceous earth (DE) as antiblock agent in an LLDPE carrier. The LLDPE in the masterbatch carrier is different than the LLDPE for the ethylene copolymer in the sealant layer. In an embodiment, the sealant layer includes:

(i) from 72 wt %, or 73 wt %, or 74 wt % to 75 wt %, or 76 wt % of the ethylene copolymer;

(ii) from 22 wt %, or 23 wt %, to 24 wt %, or 25 wt % of the 1-butene polymer, and

(iii) from greater from 1 wt %, or 2 wt % to 3 wt %, or 4 wt %, or 5 wt % of the antiblock wherein the antiblock masterbatch provides the sealant layer with from 1000 ppm, or 2000 ppm, or 3000 ppm to 4000 ppm, or 5000 ppm, or 6000 ppm antiblock agent. It is understood that the total weight of (i) the ethylene copolymer (ii) the 1-butene polymer, and (iii) the antiblock masterbatch amount to 100 wt % of the sealant layer.

A nonlimiting example of a suitable antiblock masterbatch is IP 1050, available from Ingenia Polymers.

In an embodiment, the sealant layer includes from 50 wt % to 95 wt % polypropylene or other propylene-based polymer, and from 5 wt % to 50 wt % of the 1-butene polymer having a density at a minimum of 0.913 g/cc.

2. Multilayer Film

The sealant layer is one layer in a multilayer film. The multilayer film may be fabricated into a food storage bag and into a vacuum food storage bag in particular.

In an embodiment, there is provided a vacuum packaging food storage bag that maintains the seal integrity of the peelable heat seal after heating. Such seal is a peelable seal allowing the bag to be moved, stored, handled, and cooked within, such as by microwaving or submerging in hot or boiling water without the seal loosing integrity when removing the bag from the cooking environment. The bag will be able to be picked up, stored, and handled without the weight of the food inside the bag being able to partially or completely break the seal resulting in liquids leaking from the bag or the food spilling out of the bag. The bag is formed from a multilayer film resulting in a seal strength from 4 N/15 mm to 12 N/15 mm, where 8N/15 mm is preferred.

In order to achieve this benefit, in an embodiment the bag is formed from sheets of a multilayer film pre-formed into bags or rolls of bag film for forming a bag with one open end for heat sealing after food items are inserted into the bag, the multilayer film formed from:

Alternating layers of resins including but not limited to various combinations of:

1. An oxygen barrier layer which may be nylon PA6, 66 or nylon 6 for mechanical strength, heat resistance, and clarity;

2. One or more tie or bonding layers which provide adhesive force between the successive layers;

3. A water vapor barrier layer which may be polyethylene of varying molecular weights;

and, at least one of the following layers connected by a tie layer to one of the foregoing layers:

4. An innermost layer facing the food, the innermost layer comprising, in one embodiment, a sealant resin composition compromising 50 to 95% ethylene copolymer, where said ethylene copolymers have the copolymer portion chosen from butene, hexene, or octene copolymer, having a density at a minimum of 0.918 g/cc, and 5% to 50% of 1-butene polymer having a density at a minimum of 0.913 g/cc.

In an embodiment, the multilayer film includes an oxygen barrier layer in addition to the sealant layer. Nonlimiting examples of suitable materials for the oxygen barrier layer include polyamide (PA), nylon 6, nylon 6,6 or nylon 6,66, or ethylene vinyl alcohol (EVOH). A tie layer is present between the sealant layer and the oxygen barrier layer.

In an embodiment, the multilayer film includes a water vapor barrier layer in addition to the sealant layer. Nonlimiting examples of suitable materials for the water vapor barrier include ethylene-based polymer, such as LLDPE. The LLDPE can be the same as the LLDPE present in the sealant layer or can be different than the LLDPE present in the sealant layer. In a further embodiment, the LLDPE in the water vapor barrier layer is different than the LLDPE present in the sealant layer. A tie layer is present between the water vapor layer and the sealant layer.

In an embodiment, the multilayer film includes one or more oxygen barrier layer(s) and one or more water vapor barrier layer(s) in addition to the sealant layer. The oxygen barrier layer(s) are in alternating relation with respect to the water vapor layers. Tie layers bond adjoining layers.

FIG. 1 shows an embodiment of the present multilayer film. In FIG. 1, multilayer film 10 includes sealant layer 12. Sealant layer 12 is the innermost layer and is the food contact layer when the film is fabricated into a food storage bag. The sealant layer 12 can be any sealant layer as disclosed herein.

The multilayer film 10 includes alternating layers of materials which comprise oxygen barrier material, water vapor barrier material, and tie material. The multilayer film 10 includes a tie layer 14 which adjoins an oxygen barrier layer 16 to the sealant layer 12. The oxygen barrier layer 16 can be any oxygen barrier layer as disclosed herein. In an embodiment, the oxygen barrier layer 16 is composed of nylon.

A second tie layer 18 adjoins the oxygen barrier layer 16 to a water vapor barrier layer 20. The second tie layer 18 may be composed of the same material as the tie layer 14, or may be composed of a material different than the material of the tie layer 14. The water vapor barrier layer 20 can be any water vapor barrier layer as disclosed herein. In an embodiment, the water vapor barrier layer is an LLDPE that is different than the LLDPE present in the sealant layer 12. The water vapor barrier layer 20 that is an LLDPE provides the multilayer film with strength.

The multilayer film 10 also includes a third tie layer 22 which adjoins the water vapor barrier layer 20 to a second oxygen barrier layer 24. The second oxygen barrier layer 24 is the outermost layer of the multilayer film 10. The second oxygen barrier layer 24 may be any oxygen barrier layer as disclosed herein. The second oxygen barrier layer 24 may be composed of the same material as the oxygen barrier layer 16, or may be composed of a material that is different than the material of the oxygen barrier layer 16.

The oxygen barrier layer 16 and the second oxygen barrier layer 24 each is composed of a material selected polyamide, nylon 6, and nylon 6,6. In an embodiment, the second oxygen barrier layer 24 is composed of the same nylon material that is present in the oxygen barrier layer 16.

The multilayer film 10 is a coextruded film and has a thickness from 50 microns, or 70 micron, or 80 microns to 90 microns, or 100 microns, or 110 microns, or 115 microns, or 120 microns, or 125 microns, or 130 microns.

In an embodiment, the multilayer film 10 is a seven layer film with a thickness from 70 microns to 102 microns and has

1. a sealant layer, that may be any sealant layer as previously disclosed herein, the sealant layer composed of:

(i) from 73 wt %, or 74 wt % to 75 wt %, or 76 wt % of LLDPE;

(ii) from 22 wt %, or 23 wt % to 24 wt %, or 25 wt % of the 1-butene polymer, and

(iii) from 0 wt %, or 1 wt % to 2 wt % to 3 wt %, or 4 wt %, or 5 wt % of the antiblock masterbatch;

2. a first tie layer bonded to the sealant layer;

3. a first oxygen barrier layer bonded to the first tie layer, the first oxygen barrier composed of a nylon;

4. a second tie layer bonded to the first oxygen barrier layer;

5. a water vapor layer bonded to the second tie layer, the water vapor layer composed of an LLDPE that is different than the LLDPE in the sealant layer;

6. a third tie layer bonded to the water vapor layer; and

7. a second oxygen barrier layer (which is the outermost layer) bonded to the third tie layer, the second oxygen barrier layer composed of a nylon (hereafter Film 1); and

Film 1 has one, some, or all of the following properties:

(i) from 20 vol %, or 23 vol % to 24 vol %, or 25 vol % sealant layer (based on total volume of the multilayer film); and/or

(ii) from 22 vol %, or 25 vol %, or 27 vol % to 28 vol %, or 29 vol %, or 31 vol %, or 33, vol %, or 35 vol %, or 37 vol % of oxygen barrier layer (aggregate volume % of first and second oxygen barrier layers and based on total volume of the multilayer film); and/or

(iii) an oxygen transmission rate from 37.2 or 38.8, or 40.3 to, or 42.0, or 45.0, or 48.0, or 51.0, or 54.2 cc/m²/day (24 hr); and/or

(iv) a water vapor transmission rate from 6.2, or 7.0 to 7.75 gm/m²/day (24 hr).

3. Food Storage Bag

The present multilayer film can be fabricated into a food storage bag. In an embodiment, the present disclosure provides a food storage bag which includes opposing flexible multilayer films. The multilayer films are superimposed upon each other to form a common peripheral edge. Each multilayer film includes a sealant layer. The sealant layers face each other and each sealant layer includes (i) from 50 wt % to 95 wt % ethylene copolymer having a density of at least 0.918 g/cc and (ii) from 50 wt % to 5 wt % of a 1-butene polymer having a density of at least 0.913 g/cc. The food storage bag includes a heat seal along at least a portion of the common peripheral edge.

The sealant layer can be any sealant layer as disclosed herein.

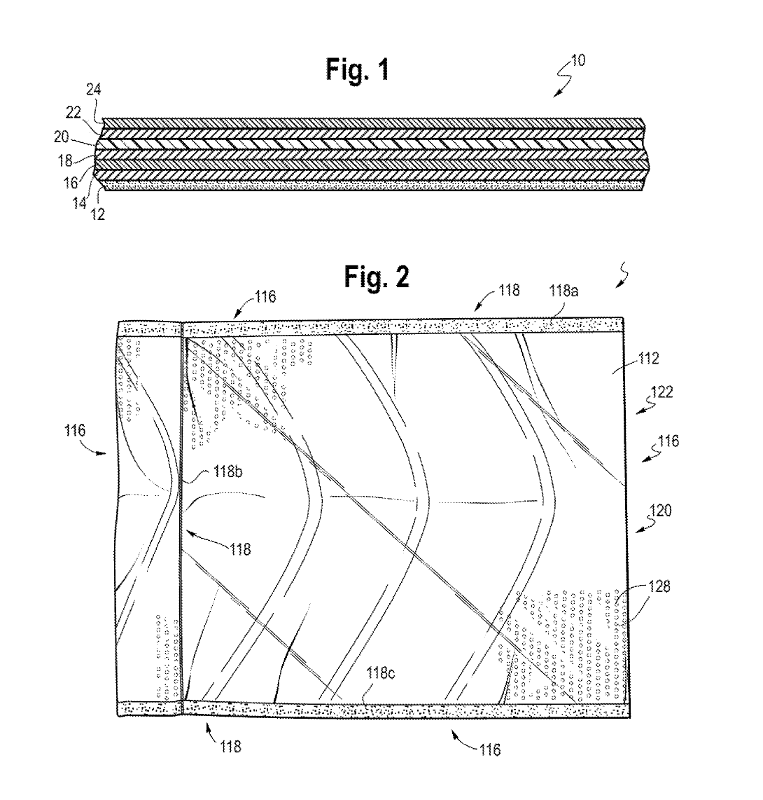

FIGS. 2-5 show an embodiment of the food storage bag wherein a food storage bag 110 is provided. Opposing flexible multilayer films 112, 114 are superimposed upon each other to form a common peripheral edge 116. Each multilayer film 112, 114 includes a sealant layer. The sealant layers face each other and each sealant layer includes (i) from 50 wt % to 95 wt % ethylene copolymer having a density of at least 0.918 g/cc and (ii) from 50 wt % to 5 wt % of a 1-butene polymer having a density of at least 0.913 g/cc.

Flexible multilayer films 112, 114 each can be any multilayer film disclosed herein. The structure and composition of each multilayer film 112, 114 can be the same, or can be different. Each multilayer film 112, 114 includes a sealant layers composed of (i) from 50 wt % to 95 wt % ethylene copolymer having a density of at least 0.918 g/cc and (ii) from 50 wt % to 5 wt % of a 1-butene polymer having a density of at least 0.913 g/cc.

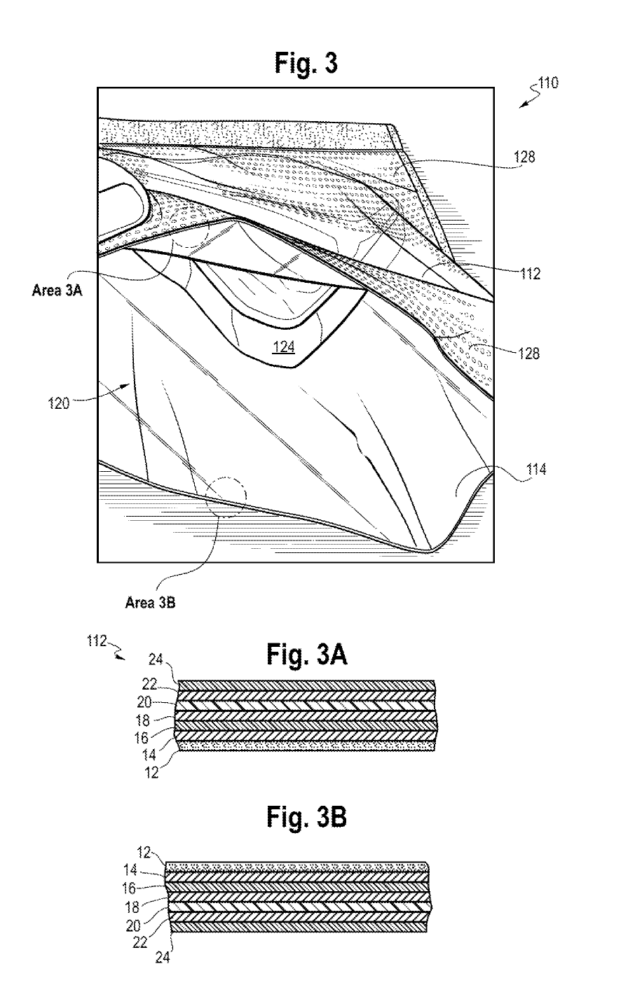

In an embodiment, each multilayer film 112, 114 is a 7-layer multilayer film as shown in FIGS. 3A and 3B. In an embodiment, the structure and the composition for each multilayer film 112, 114 is the same. Each multilayer film includes the following layer structure: sealant/tie/oxygen barrier/tie/water barrier/tie 2^{nd} oxygen barrier as shown in FIGS. 3A and 3B.

In a further embodiment each of multilayer films has the structure of multilayer film 10 of FIG. 1 namely, sealant layer 12, first tie layer 14, oxygen barrier layer 16, second tie layer 18, water vapor barrier layer 20, third tie layer 22, and second oxygen barrier layer 24.

The multilayer films 112, 114 are arranged so that the sealant layer of each respective multilayer film faces the sealant layer of the other multilayer film. FIGS. 3A, 3B are enlarged sectional views of respective areas 3A, 3B in FIG. 3. FIGS. 3A, 3B show the layer configuration for each of multilayer film 112, 114. The films are subjected to a heat sealing procedure which heat seals the multilayer films 112, 114 to each other. A “heat sealing procedure” includes a heat seal apparatus with opposing heat seal bars and additional suitable structure and mechanism (i) to move the seal bars toward each other, (ii) to apply heat and pressure to the multilayer films 112, 114, and (iii) move the seal bars away from each other in order to seal the sealant layer of each multilayer film 112, 114 to each other.

A heat seal 118 extends along at least a portion of the common peripheral edge 116. The heat seal can extend around the entire perimeter of the food storage bag 110. Alternatively the heat seal can extend around a portion of the food storage bag 110 perimeter.

The heat seal 118 can be a (i) peel seal, (ii) a hard seal, or (ii) a combination of (i) and (ii). A “peel seal” is a heat seal that is manually separable (or peelable) without destruction of the film. A “hard seal” is a heat seal that is not manually separable without destruction of the film. In general, a peel seal is designed to be separable or openable with application of finger pressure or hand pressure to the seal. A hard seal is designed to remain intact with application of finger pressure or hand pressure to the seal. In other words, a hard seal has a peel seal strength that is greater than the tensile strength of the film.

FIG. 2 shows heat seal 18 forms a storage compartment 120 in the food storage bag 110.

The food storage bag 110 has an open end 122 allowing access to the storage compartment 120. In an embodiment, a comestible 124 (a piece of choice meat in FIG. 3) is placed in the storage compartment 120 by way of open end 124. After the comestible 124 is placed in the storage compartment, the open end 124 is subsequently heat sealed closed.

The food storage bag 110 has a perimeter shape that is a polygon. The “perimeter shape” is the shape formed by the perimeter of the food storage bag 110 when the empty food storage bag 110 is laid flat as shown in FIG. 2. A “polygon” is a closed-plane figure bounded by at least three sides. The polygon can be a regular polygon, or an irregular polygon having three, four, five, six, seven, eight, nine, ten or more sides. Nonlimiting examples of suitable polygonal shapes include triangle, square, rectangle, diamond, trapezoid, parallelogram, hexagon and octagon.

In an embodiment, the food storage container 110 has a perimeter shape that is a rectangle as shown in FIG. 2. The heat seal 118 has segments. The heat seal 118 includes heat seal segment 118a, heat seal segment 118b, and heat seal segment 118c. Heat seal segments 118a, 118b, and 118c each extends along a respective side of the rectangle.

In an embodiment, heat seal segment 118a is a peel seal, heat seal segment 118b is a hard seal, and heat seal segment 118c is a peel seal. Peel seal 118a, 118c each has a seal strength from 4 N/15 mm, or 6 N/15 mm, or 8 N/15 mm to 10 N/15 mm, or 12 N/15 mm. In another embodiment, heat seal segment 118a, 118b, and 118c each is a peel seal. Each heat seal segment 118a, 118b, 118c has a seal strength from 4 N/mm, or 6 N/mm, or 8 N/mm to 10 N/mm, or 12 N/mm.

In an embodiment, each of heat seal segments 118a, 118b, and 118c is a hard seal.

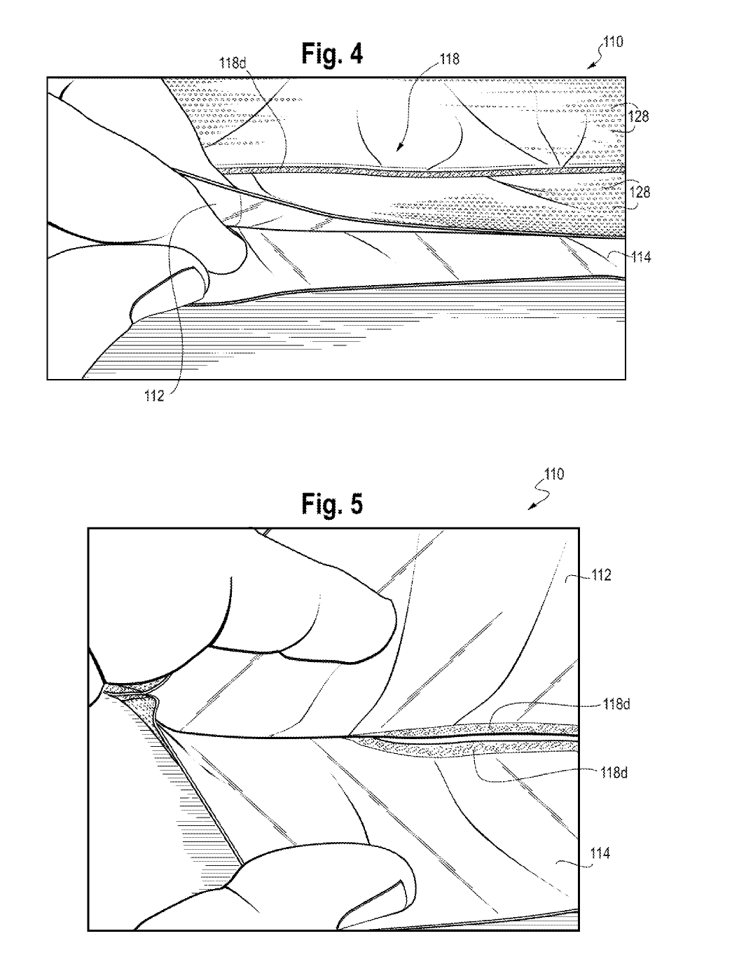

FIG. 4 shows the food storage bag 110 after the open end 122 is closed by way of a heat seal segment 118d. In FIG. 4, the comestible 124 is present in the storage compartment 122. Heat seal segments 118a, 118b, 118c, and 118d extend around the entire perimeter of the food storage bag 110, forming a closed storage compartment and concomitantly forming a closed food storage container.

In an embodiment, the volume of the closed storage compartment 120 is from a pint (16 ounces (oz), 0.473 Liters (L)), or a quart (32 oz, 0.946 L), or two quarts (64 oz, 1.89 L) to three quarts (96 oz, 2.84 L), or a gallon (128 oz, 3.79 L), or two gallons (256 oz, 7.58 L), or five gallons (640 oz, 18.95 L).

FIG. 5 shows the closed storage compartment 120 being opened by hand along heat seal segment 118d. Heat seal segment 118d has a seal strength from 4 N/15 mm, or 6 N/15 mm, or 8 N/15 mm to 10 N/15 mm, or 12 N/15 mm. In an embodiment, heat seal segments 118a, 118b, and 118c each is a hard seal, and heat seal segment 118d is a peel seal having a seal strength from 4 N/15 mm, or 6 N/15 mm, or 8 N/15 mm to 10 N/15 mm, or 12 N/15 mm.

FIGS. 2-4 show a further embodiment of the food storage bag 110 wherein multilayer films 112, 114 each include embossment 128. Embossment 128 promotes (i) heat sealing between the sealant layers for the multilayer films 112, 114 and (ii) evacuation of air from the storage compartment during a vacuum sealing operation. The present food storage bag is suitable for use with a vacuum sealing device such as the FOODSAVER® vacuum sealing device and/or GAMESAVER® vacuum sealing device.

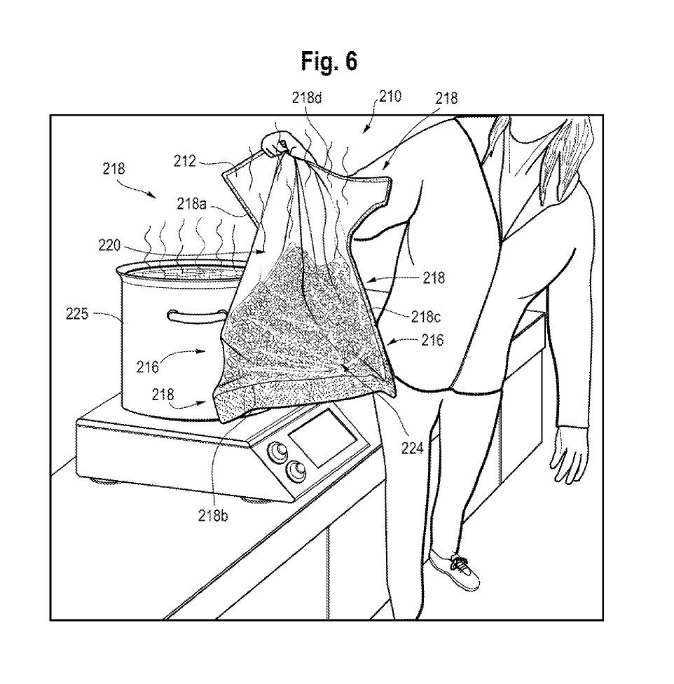

FIG. 6 shows a food storage bag 210 having opposing flexible multilayer films 212, 214 are superimposed upon each other to form a common peripheral edge 216. The multilayer films 212, 214 each can be any multilayer film disclosed herein. The sealant layer for each multilayer film 212, 214 face each other, each sealant layer composed of (i) from 50 wt % to 95 wt % ethylene copolymer having a density of at least 0.918 g/cc and (ii) from 50 wt % to 5 wt % of a 1-butene polymer having a density of at least 0.913 g/cc. The sealant layer can be any sealant layer as previously disclosed herein.

A heat seal 218 extends along the entire the common peripheral edge 216. The heat seal 218 forms a closed storage compartment 220. In the storage compartment 220, is a comestible, namely a soup 224. The heat seal 218 includes seal segments 218a, 218b, 218c, 218d. Seal segments 218a, 218c, and 218d are peel seals. Each seal segment 218a, 218c, 218d has a seal strength from 4 N/15 mm, or 6 N/15 mm, or 8 N/15 mm to 10 N/15 mm, or 12 N/15 mm.

FIG. 6 shows the food storage bag 210 removed from a pot 225 of boiling water. The food storage container 210 is immersed in the boiling water (100° C.) for a duration from one hour (hr), or 2 hrs, or 3 hrs, or 4 hrs, or 5 hrs, or 7 hrs, or 10 hrs to 18 hrs, or 24 hrs, or 36 hrs, or 48 hrs in order to fully cook, or otherwise boil, the comestible 224.

Applicant discovered that food storage bag (110, 210) having heat seals formed with opposing sealant layers, each sealant layer composed of (i) from 50 wt % to 95 wt % ethylene copolymer having a density of at least 0.918 g/cc and (ii) from 50 wt % to 5 wt % of a 1-butene polymer having a density of at least 0.913 g/cc surprisingly: (1) maintains the heat seal (no leakage) after being subjected to immersion in boiling water (100° C.) for a duration from one hour (hr), or 2 hrs, or 3 hr, or 4 hrs, or 5 hrs, or 7 hrs or 10 hrs to 18 hrs, or 24 hrs, or 36 hrs, or 48 hrs; (2) the food storage bag (110, 210) simultaneously provides at least one seal segment that is a peel seal with a seal strength from 4 N/15 mm, or 6 N/15 mm, or 8 N/15 mm to 10 N/15 mm, or 12 N/15 mm after being subjected to immersion in boiling water for the above-stated duration; (3) the food storage bag (110, 210) passes the boil test; and (4) the food storage bag (110, 210) passes the hot drop test. The ability of the present food storage bag (110, 210) to provide at least one peel seal with no leakage of boiling hot contents therefrom and pass the hot drop test is unexpected.

In an embodiment, food storage bag 110 and/or 210 is a vacuum packaging food storage bag. A “vacuum packaging food storage bag,” as used herein, is storage bag from which air is removed, under vacuum, from the bag prior to heat sealing. This method involves (manually or automatically) placing a comestible in the food storage bag 110, 210, removing air from the storage compartment by way of vacuum (i.e., negative pressure), and subsequently heat sealing the food storage bag.

### Test Methods

Boil test and Hot drop test. The boil test and the hot drop test are conducted by performing the steps 1-11 below.

1. Cut and seal a one gallon bag from 11″ roll (15″×11″).

2. Fill the food storage bag with one gallon of water.

3. Provide a 2 inch gap between the open edge of the bag and the top of the water line.

4. Heat seal the open edge under the heat seal conditions on Table 3.

5. Place the food storage bag in a pot of boiling water.

6. Allow the food storage bag to sit in the boiling water for 10 minutes or until the water in the food storage bag is boiling.

7. Remove the food storage bag from the pot by grasping the two edges of the permanent seal so that the peel seal is on the bottom, the peel seal supporting the weight of the water.

8. Observe whether water is leaking from the peal seal. (end boil test)

9. Hold the food storage bag at a height of 40 inches (100 cm) above a wood floor or a tile floor.

10. Drop the food storage bag unto the floor.

11. Observe whether food storage bag in is leaking or whether any of the seals failed. If bag has not failed in this drop, re-drop on flat side from 40″ so 11×15″ face impacts floor. If no leakage or breakage occurs, bag is considered pass. (end hot drop test)

Density is measured in accordance with ASTM D 792. The result is recorded in grams (g) per cubic centimeter (g/cc or g/cm³).

Melt index (MI) measurement for ethylene-based polymers and 1-butene based polymers is performed according to ASTM D1238, Condition 190° C./2.16 kilogram (kg) weight, formerly known as “Condition E” and also known as I2, and is reported in grams eluted per 10 minutes. Melt index is inversely proportional to the molecular weight of the polymer. Thus, the higher the molecular weight, the lower the melt index, although the relationship is not linear.

Melt temperature, or “Tₘ” as used herein (also referred to as a melting peak in reference to the shape of the plotted DSC curve) is measured by DSC (Differential Scanning calorimetry) in accordance with ASTM D 3418 with results reported in degrees Celsius (° C.).

Oxygen transmission rate is measured on a flat film in accordance with ASTM D 3985 at 23° C., 0% relative humidity (RH).

Water transmission rate is measured on a flat film in accordance with ASTM F1249 at 23° C., 0% RH.

Peel seal strength is measured in accordance with ASTM D882. Results are reported in Newtons per 15 millimeter (N/15 mm).

Some embodiments of the present disclosure will now be described in detail in the following Examples.

1. Multilayer Films

Multilayer films with seven layer structure are formed by coextruding the components in Table 1 below.

TABLE 1
Multilayer film structure

| Layer | Position | Material |
|---|---|---|
| 7 | Outermost layer | Nylon 6,66 or 6,6 |
| 6 | Inner | Tie |
| 5 | Inner | LLDPE |
| 4 | Inner | Tie |
| 3 | Inner | Nylon 6,66 or 6,6 |
| 2 | Inner | Tie |
| 1 | Sealant layer (Innermost, | Various-see Tables 2, 4 |
| | food contact) | |

Different multilayer films are produced by altering the composition of the sealant layer. The composition for each of layers 2-7 remains constant in the multilayer films. The composition of the sealant layer is varied. Materials used in the sealant layers are provided in Table 2 below.

TABLE 2
Materials for sealant layer

| Material | Properties | Tradename | Source |
|---|---|---|---|
| LLDPE | Linear low density | 1015HA | ExxonMobil |
| | polyethylene | | |
| LLDPE | LLDPE (ethylene/octene | FP120 | Nova Chemicals |
| | copolymer) | | |
| | Density 0.920 g/cc | | |
| | Ml 1.0 | | |
| 8640 | 1-butene homopolymer | PB8640 | LyondellBassell |
| | Density 0.906 g/cc | | |
| | Ml 1.0 | | |
| | Tm 97° C. | | |
| 0110M | 1-butene homopolymer | PB0110M | LyondellBassell |
| | Density 0.914 g/cc | | |
| | Ml 0.4 | | |
| | Tm 117° C. | | |

2. Food Storage Bags

Nine pairs of multilayer films are produced, each pair having a different composition profile in the sealant layers. Each multilayer film has a thickness of 3 mils and is non-oriented. For each film pair, the individual opposing multilayer films (with sealant layers facing each other) are heat sealed together along the common peripheral edge to form a food storage bag having the rectangle shape as shown in FIG. 2. The food storage bag has three seal segments and an open end as shown in FIG. 2. The three seal segments are permanent heat seals.

Each food storage bag is filled with one gallon of water. The open end of the food storage bag is subsequently heat sealed closed to completely contain the one gallon of water within the storage compartment of the food storage bag.

The open end of the food storage container is heat sealed closed under the heat seal conditions shown in Table 3. The Table 3 heat seal conditions form a heat seal segment that is a peel seal.

TABLE 3
Heat seal conditions

| Heat seal conditions | Value |
|---|---|
| Seal bar temperature | 163° C. |
| Profile pressure | 124 kPa +/− 13 kPa⁺ |
| Dwell time | 6 seconds |

⁺kPa—kiloPascals

The open end is closed by forming a heat seal segment similar to heat seal segment 118d in FIG. 4. The heat seal segment 118d is a peel seal having a seal strength from 4 N/15 mm to 12 N/15 mm.

The nine different food storage bags are evaluated for seal performance. The composition of the sealant layer, peel seal strength, boil test, and hot drop test are provided in Table 4 below.

TABLE 4
Performance of food storage bags

| | PEEL | | | | |
|---|---|---|---|---|---|
| Film | STRENGTH | Hot | Boil | Sealant layer | Vol % |
| Designation | (N/15 mm) | Drop Test | Test | Formulation | Sealant layer |
| CS1 | 6.17 | NOT DONE | FAIL | Exxon 1015HA/ | 20% sealant |
| | | | | 8640 | |
| CS2 | 7.30 | PASSED | FAIL | FP120/8640 | 20% sealant |
| IE3 | 11.55 | PASSED | PASSED | FP120/25% | 20% sealant |
| | | | | 0110M | |
| IE4 | 10.14 | PASSED | PASSED | FP120/25% | 20% sealant |
| | | | | 0110M | |
| IE5 | 9.69 | PASSED | PASSED | FP120/22% | 20% sealant |
| | | | | 0110M | |
| IE6 | 10.24 | PASSED | PASSED | FP120/22% | 20% sealant |
| | | | | 0110M | |
| IE7 | 10.50 | PASSED | PASSED | FP120/25% | 25% sealant |
| | | | | 0110M | |
| IE8 | 9.87 | PASSED | PASSED | FP120/25% | 25% sealant |
| | | | | 0110M | |
| IE9 | 12.53 | PASSED | PASSED | FP120/22% | 25% sealant |
| | | | | 0110M | |

*Vol % of sealant layer is based on total volume of the multilayer film
CS—comparative sample
IE—inventive example

Normally the heat sealed section of a structure of a food storage bag, and a vacuum packaging food storage bag in particular, cannot be separated by hand as the peal seal strength is greater than 15N/15 mm. In fact the plastic film material above or below the heat seal normally tears before the two heat sealed faces of the bag will peel open. With normal heat seal technology, the difficulty is that the peel strength or opening force of the resulting heat seal is diminished when exposed to heat. Bags subjected to boiling water or a microwave oven reduce the seal strength to the point where the food in the storage compartment will fall out of the bag from the seal when the bag is picked up.

Applicant discovered food storage bags (and vacuum packaging food storage bags in particular) made from multilayer film with the present sealant layer yield a peel seal that is strong enough to withstand handling (i.e., the peel seal remaining sealed) after being subjected to cooking or heating temperatures which may include boiling water, microwave, or steam the food storage bags passing the boil test, and/or passing the hot drop test while simultaneously having a peel seal strength that is still low enough so that the peel seal can be opened by hand.

It is specifically intended that the present disclosure not be limited to the embodiments and illustrations contained herein, but include modified forms of those embodiments including portions of the embodiments and combinations of elements of different embodiments as come within the scope of the following claims.

1. A multilayer film comprising:
a sealant layer comprising from (i) 50 wt % to 95 wt % ethylene copolymer having a density of at least 0.918 g/cc and (ii) from 50 wt % to 5 wt % of a 1-butene polymer having a density of at least 0.913 g/cc.

2. The multilayer film of claim 1 wherein the ethylene copolymer is selected from the group consisting of ethylene/butene copolymer, ethylene/hexene copolymer, and ethylene/octene polymer.

3. The multilayer film of claim 1 comprising an oxygen barrier layer.

4. The multilayer film of claim 1 comprising a water vapor barrier layer.

5. The multilayer film of claim 1 comprising an oxygen barrier layer and a water vapor barrier layer.

6. The multilayer film of claim 1 comprising a tie layer between the sealant layer and an oxygen barrier layer.

7. The multilayer film of claim 6 comprising a second tie layer between the oxygen barrier layer and a water vapor layer.

8. The multilayer film of claim 7 comprising a third tie layer between the water vapor layer and a second oxygen barrier layer.

9. The multilayer film of claim 8 wherein the second barrier layer is an outermost layer.

10. The multilayer film of claim 1 comprising
a first tie layer bonded to the sealant layer;
a first oxygen barrier layer bonded to the first tie layer;
a second tie layer bonded to the first oxygen barrier layer;
a water vapor layer bonded to the second tie layer;
a third tie layer bonded to the water vapor layer; and
a second oxygen barrier layer bonded to the third tie layer.

11. The multilayer film of claim 1 wherein the first oxygen barrier layer and the second oxygen barrier layer each is composed of a material selected from the group consisting of a nylon.

12. A food storage bag comprising:
opposing flexible multilayer films superimposed upon each other to form a common peripheral edge;
each multilayer film comprising a sealant layer, the sealant layers facing each other,
each sealant layer comprising
(i) from 50 wt % to 95 wt % ethylene copolymer having a density of at least 0.918 g/cc and
(ii) from 50 wt % to 5 wt % of a 1-butene polymer having a density of at least 0.913 g/cc; and
a heat seal along at least a portion of the common peripheral edge.

13. The food storage bag of claim 12 wherein at least a portion of the heat seal is a peel seal.

14. The food storage bag of claim 13 wherein the heat seal forms a storage compartment in the food storage bag.

15. The food storage bag of claim 14 comprising a comestible in the storage compartment.

16. The food storage bag of claim 15 wherein the food storage bag has a perimeter shape that is a rectangle; and
the heat seal comprises a heat seal segment extending along each side of the rectangle.

17. The food storage bag of claim 16 wherein at least one heat seal segment is a peel seal.

18. The food storage bag of claim 17 wherein the at least one peel seal has a seal strength from 4 N/15 mm to 12 N/15 mm.

19. The food storage bag of claim 18 wherein the bag passes the boil test.

20. The food storage bag of claim 19 wherein the bag passes the hot drop test.
